(19) United States
(12) Patent Application Publication
(10) Pub. No.: US 2008/0012842 A1
(43) Pub. Date: Jan. 17, 2008

(54) IMAGE DISPLAY DEVICE COMPRISING FIRST AND SECOND GATE DRIVER CIRCUITS FORMED ON SINGLE SUBSTRATE

(75) Inventor: Seiichirou Mori, Tokyo (JP)

Correspondence Address: OBLON, SPIVAK, MCCLELLAND MAIER & NEUSTADT, P.C., 1940 DUKE STREET, ALEXANDRIA, VA, 22314, US

(73) Assignee: MITSUBISHI ELECTRIC CORPORATION, Chiyoda-ku (JP)

(21) Appl. No.: 11/742,246

(22) Filed: Apr. 30, 2007

(30) Foreign Application Priority Data
Jul. 13, 2006 (JP) 2006-192480

(51) Int. Cl. G09G 3/36; G09G 5/00

(52) U.S. Cl. 345/206

(57) ABSTRACT

A first gate driver circuit scans gate lines in one direction, and has its gate pulse output stages capable of having high impedance in response to an external signal. A second gate driver circuit scans gate lines in one but different direction from the first gate driver circuit, and has its gate pulse output stages capable of having high impedance in response to the external signal. When one of the first and second gate driver circuits is operating under the control of the external signal, the respective gate pulse output stages of the other gate driver circuit have high impedance. Consequently, a plurality of shifting techniques such as a scan direction switching function of gate lines in an image display device including a-Si gate driver circuits can be implemented.

### BACKGROUND OF THE INVENTION

1. Field of the Invention

The present invention relates to a technique for driving an image display device including gate driver circuits (hereinafter also referred to as a-Si gate driver circuits) formed of amorphous silicon TFTs (a-Si TFTs).

2. Description of the Background Art

Japanese Patent Application Laid-Open No. 2004-246358 (JP2004-246358) presents a block diagram in FIG. 2 showing an exemplary configuration of a gate driver IC including shift registers formed of a-Si TFTs for driving gate lines of a liquid crystal panel, an organic electroluminescent (EL) display panel, or the like. In this circuit configuration, the n-th stage shift register receives the output from the (n−1)th stage shift register, and the output from the (n+1)th stage shift register is used for resetting the output from the n-th stage shift register.

Generally, in order to implement a scan direction switching function (bidirectional scan) in an image display panel, it is necessary to implement a circuit function of switching the shift direction of shift registers of respective stages in gate driver circuits, or to physically switch the connection between the output stage of each shift register or gate pulse output stage (gate pulse output stage is an output signal from a shift register with low impedance so as to drive a gate line) and a corresponding gate line.

To switch connection between stages or to physically switch the connection between the output stage of each shift register or gate pulse output stage and a corresponding gate line, a switching circuit formed of an a-Si TFT needs to be provided in each stage.

FIG. 17 shows a circuit configuration (non-prior art) in which switching circuits for implementing the scan direction switching function are added to the circuit configuration shown in FIG. 2 of the aforementioned JP2004-246358.

A positive bias or a negative bias is dc applied to each of the switching circuits shown in FIG. 17. Therefore, driving these circuits for a certain period of time or longer arises problems in that shift registers are reduced in operating margin or fail to operate due to the shift in threshold voltage (Vth) of a-Si TFT devices used in the respective switching circuits.

The shift in threshold voltage (Vth) of TFT devices caused by the application of a dc bias is significantly encountered particularly in a-Si TFTs. The aforementioned JP2004-246358 also mentions such progressing degradation of a-Si TFTs in paragraphs 0018 to 0021.

On the foregoing reasons, it is difficult to implement the scan direction switching function of gate lines with the circuit configuration shown in FIG. 2 of JP2004-246358, and if such function is implemented, it is absolutely necessary to add circuits compensating for the shift in threshold voltage (Vth) of a-Si TFT devices, which disadvantageously increases gate driver circuits in scale.

Such size increase of gate driver circuits causes a problem in that an image display panel is increased in frame size since the gate driver circuits are disposed on the periphery of the image display panel.

### SUMMARY OF THE INVENTION

An object of the present invention is to implement a plurality of shifting techniques such as a scan direction switching function of gate lines in an image display device including a-Si gate driver circuits, by using gate driver circuits each capable of effecting scanning only in one direction.

The image display device according to the present invention includes, on a single substrate, a plurality of pixels arrayed in a matrix, a plurality of gate lines and a plurality of source lines defining the matrix, a first gate driver circuit, and a second gate driver circuit. The first gate driver circuit scans the plurality of gate lines in a first direction, and includes gate pulse output stages each being capable of having high impedance in response to an external signal. The second gate driver circuit scans the plurality of gate lines in a second direction, and includes gate pulse output stages each being capable of having high impedance in response to the external signal. Each of the gate pulse output stages of the first gate driver circuit and each of the gate pulse output stages of the second gate driver circuit are connected to each other through a corresponding gate line. When one of the first and second gate driver circuits is operating under the control of the external signal, the gate pulse output stages of the other one of the first and second gate driver circuits have high impedance, so that the other one of the first and second gate driver circuits exerts no influence upon scanning effected by the operating one of the first and second gate driver circuits.

This easily achieves the scan direction switching of gate lines (e.g., switching between normal scanning and reverse scanning) in an image display device including a-Si gate driver circuits, by using gate driver circuits each capable of effecting scanning only in one direction.

These and other objects, features, aspects and advantages of the present invention will become more apparent from the following detailed description of the present invention when taken in conjunction with the accompanying drawings.

### BRIEF DESCRIPTION OF THE DRAWINGS

FIG. 1 is a circuit diagram showing a configuration of an image display device according to a first preferred embodiment of the present invention;

FIG. 2 is a timing chart showing the operation of the circuit shown in FIG. 1;

FIG. 3 is a circuit diagram showing an exemplary configuration of a control signal switching circuit in the circuit shown in FIG. 1;

FIG. 4 is a circuit diagram showing another exemplary configuration of a control signal switching circuit in the circuit shown in FIG. 1;

FIG. 5 is a circuit diagram showing a configuration of an image display device according to a second preferred embodiment of the present invention;

FIG. 6 is a timing chart showing the operation of the circuit shown in FIG. 5;

FIG. 7 is a circuit diagram showing an exemplary configuration of a power supply switching circuit in the circuit shown in FIG. 5;

FIG. 8 is a circuit diagram showing another exemplary configuration of the power supply switching circuit in the circuit shown in FIG. 5;

FIG. 9 is a circuit diagram showing a configuration of an image display device according to a third preferred embodiment of the present invention;

FIG. 10 is a circuit diagram showing a configuration of an image display device according to a fourth preferred embodiment of the present invention;

FIG. 11 is a circuit diagram showing another configuration of the image display device according to the fourth preferred embodiment;

FIG. 12 is a circuit diagram showing a configuration of an image display device according to a fifth preferred embodiment of the present invention;

FIG. 13 is a circuit diagram showing a configuration of an image display device according to a sixth preferred embodiment of the present invention;

FIG. 14 is a timing chart showing the operation of the circuit shown in FIG. 13;

FIG. 15 is a circuit diagram showing a configuration of an image display device according to a seventh preferred embodiment of the present invention;

FIG. 16 is a timing chart showing the operation of the circuit shown in FIG. 15; and

FIG. 17 is a circuit diagram showing an example of adding scan direction switching circuits to a conventional circuit.

### DESCRIPTION OF THE PREFERRED EMBODIMENTS

### First Preferred Embodiment

A first preferred embodiment features arranging a first gate driver circuit for scanning gate lines in one direction on a substrate and further arranging, on the same substrate, a second gate driver circuit for scanning gate lines in one direction such that scanning is effected in the different direction from the first gate driver circuit, thereby achieving bi-directional scanning. Hereinafter, the present embodiment will be described in detail with reference to the accompanied drawings.

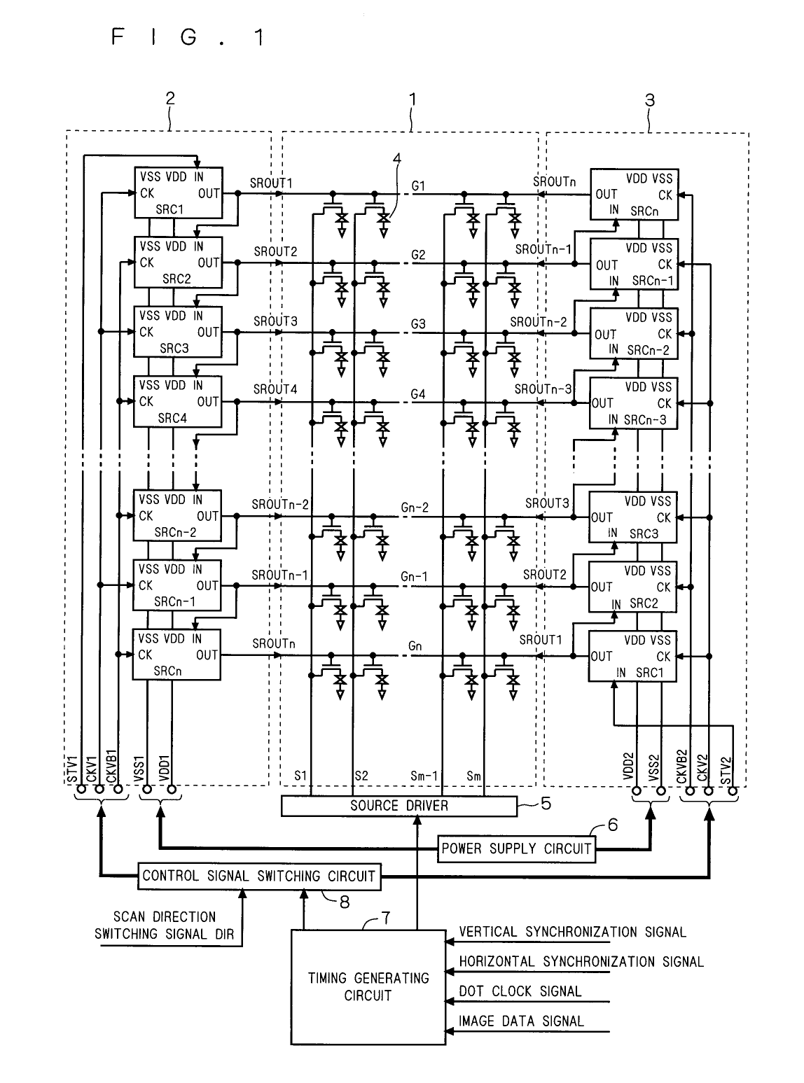

FIG. 1 is a block diagram schematically showing a configuration of a liquid crystal display device according to the present embodiment. As shown in FIG. 1, a pixel array 1, and first and second gate driver circuits 2 and 3 are formed on a glass substrate in a TFT substrate which is one of substrates constituting a liquid crystal panel. The first and second gate driver circuits 2 and 3 are formed of a-Si TFTs.

The pixel array 1 forms an m×n matrix of pixels 4. In the pixel array 1, a gate line G1 on the one end corresponds to a leading row at top of display, and a gate line Gn on the other end corresponds to the last row at bottom of display.

In accordance with the number of scanning lines or rows n in the pixel array 1, the first gate driver circuit 2 includes n shift registers SRC1 to SRCn for effecting scanning in one direction from top to bottom of display, starting from pixels 4 arrayed on the gate line G1 and ending with pixels 4 arrayed on the gate line Gn. For ease of illustration, a buffer circuit portion disposed between each gate line Gi and a shift register SRCi corresponding to the gate line Gi for driving the gate line Gi is omitted in FIG. 1 (which also applies to illustration of the second gate driver circuit 3 to be described later). As to the connection between outputs from the respective shift registers SRC1 to SRCn (gate pulse output stages) and respective gate lines G1 to Gn, SROUT1 is connected to G1, SROUT2 to G2, . . . , SROUTn−1 to Gn−1, and SROUTn to Gn.

In accordance with the number of scanning lines or rows n in the pixel array 1, the second gate driver circuit 3 includes n shift registers SRC1 to SRCn for effecting scanning in one direction from bottom to top of display, starting from pixels 4 arrayed on the gate line Gn and ending with pixels 4 arrayed on the gate line G1 (the one scanning direction is opposite to the scanning direction of the first gate driver circuit 2). As described above, a buffer circuit portion for driving each gate line Gi is omitted from illustration. As to the connection between outputs from the respective shift registers SRC1 to SRCn (gate pulse output stages) and respective gate lines G1 to Gn, SROUT1 is connected to Gn, SROUT2 to Gn−1, . . . , SROUTn−1 to G2, and SROUTn to G1.

In the example of FIG. 1, the first and second gate driver circuits 2 and 3 are arranged on the left and right sides of the pixel array 1, respectively, but may be arranged oppositely, or the both first and second gate driver circuits 2 and 3 may be arranged on the left or right side of the pixel array 1, provided that the shift registers of the gate driver circuits and gate lines are connected in the same manner as described above.

A source driver 5 is a well-known circuit for writing image data into the pixel array 1 through m columns of source lines S1 to Sm.

A power supply circuit 6 supplies supply voltages VDD and VSS to the first and second gate driver circuits 2 and 3.

A timing generating circuit 7 is a well-known circuit for providing timing necessary for the source driver 5 and first and second gate driver circuits 2 and 3 on the basis of a vertical synchronization signal, a horizontal synchronization signal, an image data signal, a dot clock signal, and the like.

A control signal switching circuit 8 is a switching circuit capable of connecting (applying) a plurality of control signals (control signals with unfixed voltage) necessary for the gate driver circuits output from the timing generating circuit 7, to one of the first and second gate driver circuits 2 and 3, in accordance with the logic of a scan direction switching signal DIR (external signal), thereby fixing the control terminal of the other one of the first and second gate driver circuits 2 and 3 at the fixed voltage VSS. In other words, the control signal switching circuit 8 functions to switch the application of control signals with unfixed voltage to the first and second gate driver circuits 2 and 3 in accordance with the level of external signal DIR.

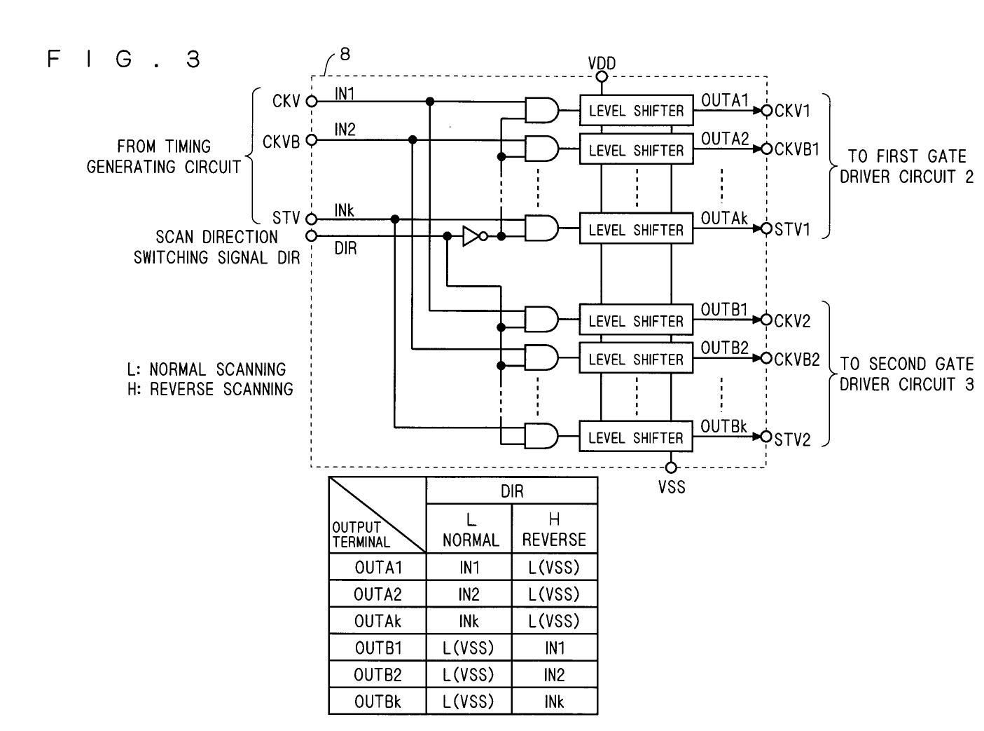

FIG. 3 is a circuit diagram showing an exemplary configuration of the control signal switching circuit 8 shown in FIG. 1. The control signal switching circuit 8 shown in FIG. 3 separates routing of a plurality of control signals (CKV, CKVB, STV) necessary for the gate driver circuits output from the timing generating circuit 7 into the route for the first gate driver circuit 2 and the route for second gate driver circuit 3, by means of an inverter circuit and a plurality of AND circuits.

Generally saying, a timing generating circuit is formed of silicon transistors and the like, which means that the supply voltage for the timing generating circuit (about 1.5 V to 3.3 V) is lower than the supply voltage for gate driver circuits formed of a-Si TFTs (VDD-to-VSS potential is about 30 V). Therefore, the control signal switching circuit 8 is provided with level shifters for changing the level of the control signals (CKV, CKVB, STV) output from the timing generating circuit 7 between H and L.

Herein, the level shifters of the control signal switching circuit 8 are formed of transistors with their threshold voltage (Vth) shifting little, such as silicon transistors, low-temperature polysilicon TFTs, or the like. In contrast, the gate driver circuits are formed of a-Si TFTs with their threshold voltage (Vth) shifting relatively significantly.

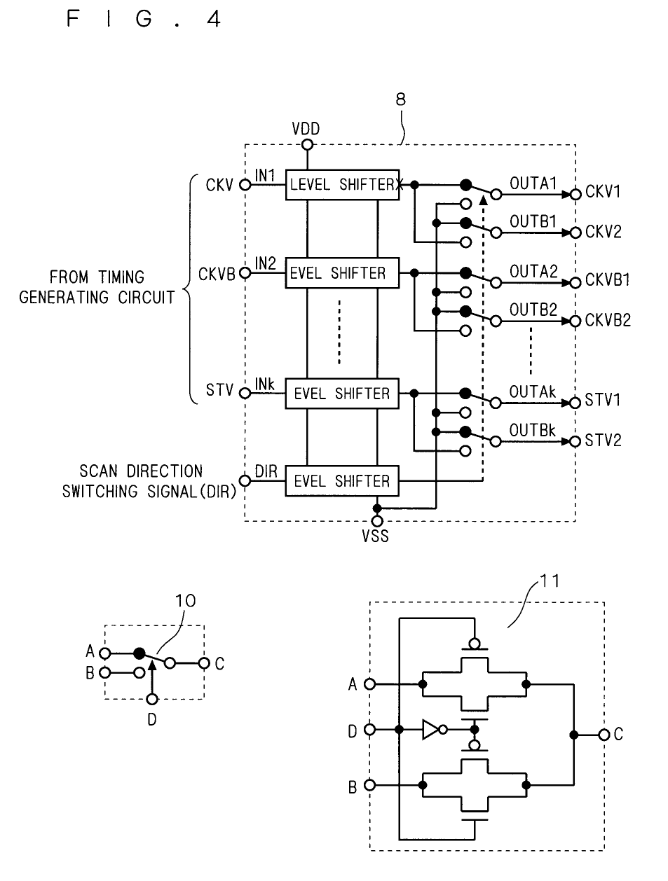

FIG. 4 is a block diagram showing another exemplary configuration of the control signal switching circuit 8 having a different configuration than the circuit shown in FIG. 3. The control signal switching circuit 8 shown in FIG. 4 is configured to first level shift the plurality of control signals (CKV, CKVB, STV) necessary for the gate driver circuits output from the timing generating circuit 7 and then to switch the plurality of control signals by analog switching circuits 10. Each analog switching circuit 10 shown in FIG. 4 includes a switching circuit formed of CMOS transistors and an inverter circuit, similarly to a circuit 11.

As described above, the level shifters of the control signal switching circuit 8 may be disposed at either stage upstream or downstream of switching of control signals.

The operation of the liquid crystal display device shown in FIG. 1 will now be described.

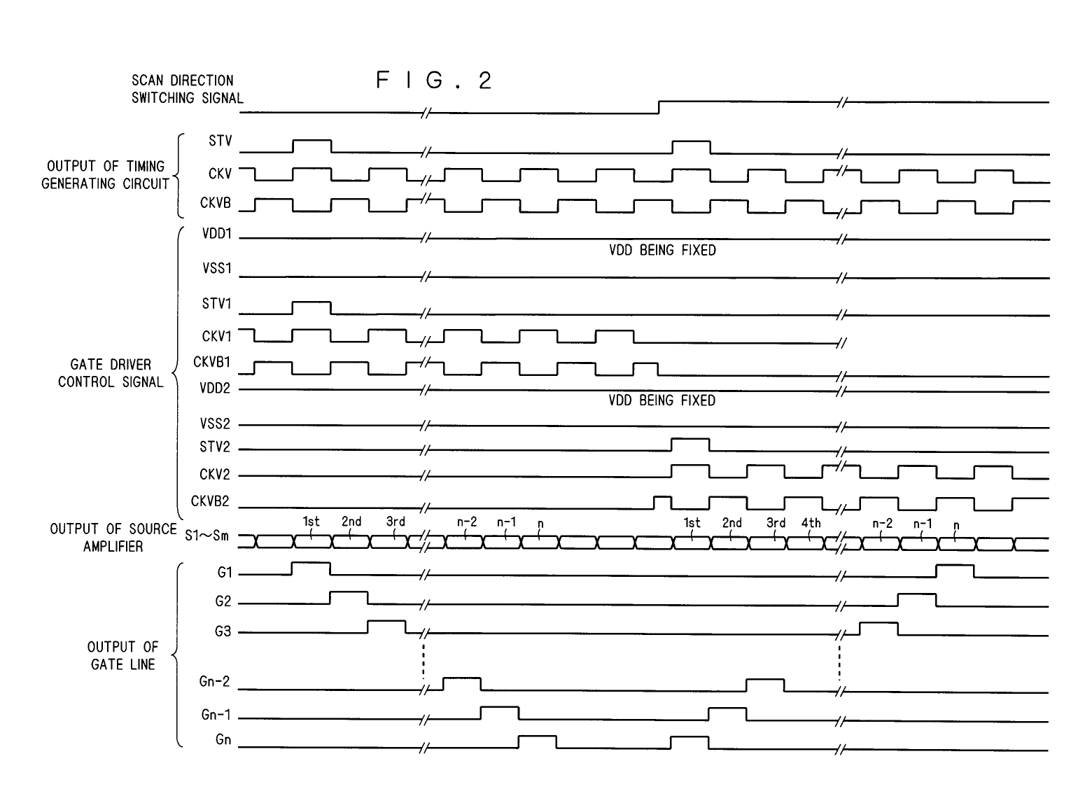

FIG. 2 is a timing chart showing the operation of the liquid crystal display device shown in FIG. 1.

Herein, the m×n pixel array 1 operates in the same way as in a conventional pixel array.

While FIG. 1 is depicted assuming a liquid crystal display device, the image display device according to the present invention only needs to be a display device for sequentially scanning gate lines, and may be an organic EL display or another type of display device, rather than liquid crystal.

The source driver 5 and timing generating circuit 7 also operate in the same way as known source driver and timing generating circuit in the conventional technique, and description thereof is also omitted.

The operation of the first gate driver circuit 2 shown in FIG. 1 is basically the same as that of a conventional gate driver circuit, such as the gate driver circuit described in the aforementioned JP2004-246358.

First, the control signal switching circuit 8 by which the present embodiment is distinguished applies the plurality of control signals (CKV, CKVB, STV) generated in and output from the timing generating circuit 7, to control signal terminals (STV1, CKV1, CKVB1) of the first gate driver circuit 2, in accordance with the level (first level) of the external signal DIR. Upon application of the signals, the first gate driver circuit 2 is brought into the operating state as “one of the gate driver circuits”. At the same time, the control signal switching circuit 8 fixes all or part of control signal terminals (STV2, CKV2, CKVB2) of the second gate driver circuit 3 (in the example shown in FIG. 2, all the control signal terminals) at the fixed voltage VSS equal to the ground level of gate driver circuits, for example (fixed voltage VSS only needs to be lower than the threshold voltage of a-Si TFTs), in accordance with the level of the external signal DIR. Application of the fixed voltage to the control signal terminals brings the gate pulse output stages SROUT1 to SROUTn of the shift registers SRC1 to SRCn of the second gate driver circuit 3 into high impedance state, so that the second gate driver circuit 3 becomes “the other one of the gate driver circuits” which is in the non-operating state during a period in which the first gate driver circuit 2 is operating. Accordingly, none of the gate pulse output stages SROUT1 to SROUTn of the shift registers SRC1 to SRCn of the second gate driver circuit 3 exerts influence upon line sequential scanning effected by the operating first gate driver circuit 2 which will be described next. The line sequential scanning of the pixel array 1 effected by the first gate driver circuit 2 alone is as described below.

First, upon receipt of the start signal STV which is one of the control signals, the output stage OUT of the first stage shift register SRC1 outputs the output pulse SROUT1. The topmost gate line G1 is thereby scanned.

As already described, the gate pulse output stages SROUT1 to SROUTn each include a buffer amplifier (not shown) capable of charging the capacity of a corresponding gate line Gi within a required period of time.

The output pulse SROUT2 of the second stage shift register SRC2 is output upon input of the output pulse SROUT1 of the first stage to the shift register SRC2.

The output pulse SROUT3 of the third stage shift register SRC3 is output upon input of the output pulse SROUT2 of the second stage to the shift register SRC3.

In this manner, the output of each of the shift registers SRC1 to SRCn is sequentially output to a corresponding gate line upon receipt of the output from a shift register of an immediately preceding stage until the n-th stage output SROUTn is output.

The first stage output SROUT1 is connected to the first gate line G1 of the pixel array 1, the second stage output SROUT2 to the second gate line G2, . . . , and the n-th stage output SROUTn to the n-th gate line Gn. When shift clocks (CKV1, CKVB1) and start signal STV1 are input only to the first gate driver circuit 2 by switching control exerted by the control signal switching circuit 8, the first gate line G1 through the n-th gate line Gn of the pixel array 1 are sequentially scanned, so that an image is displayed.

On the other hand, when the external signal DIR is reversed in level from the first level to second level, the control signal switching circuit 8, in response to the reversal, applies the plurality of control signals (STV, CKVB, CKV) generated in and output from the timing generating circuit 7 to the control signal terminals (STV2, CKV2, CKVB2) of the second gate driver circuit 3. Upon application of the signals, the second gate driver circuit 3 is brought into the operating state as “the one of the gate driver circuits”. At the same time, the control signal switching circuit 8, in response to the level reversal of external signal DIR, fixes all or part of the control signal terminals (STV1, CKV1, CKVB1) of the first gate driver circuit 2 (in the example shown in FIG. 2, all the control signal terminals) at the fixed voltage VSS equal to the ground level of gate driver circuits, for example. Application of the fixed voltage to the control signal terminals in turn causes all the gate pulse output stages SROUT1 to SROUTn of the shift registers SRC1 to SRCn of the first gate driver circuit 2 and buffer amplifiers (not shown) to have high impedance, so that the first gate driver circuit 2 becomes “the other one of the gate driver circuits” which is in the non-operating state during a period in which the second gate driver circuit 3 is operating. Accordingly, none of the gate pulse output stages SROUT1 to SROUTn of the shift registers SRC1 to SRCn of the first gate driver circuit 2 exerts influence on line sequential scanning effected by the operating second gate driver circuit 3 which will be described next. The line sequential scanning of the pixel array 1 effected by the second gate driver circuit 3 alone is as described below.

Herein, the second gate driver circuit 3 includes shift registers similarly to the first gate driver circuit 2, as illustrated in FIG. 1 by way of example. The second gate driver circuit 3 differs from the first gate driver circuit 2 only by the connection between the gate lines of the pixel array 1 and outputs from the shift registers. More specifically, the second gate driver circuit 3 and gate lines of the pixel array 1 are connected such that the first stage output SROUT1 is connected to the n-th gate line Gn, the second stage output SROUT2 to the (n−1)th gate line Gn−1, . . . , and the n-th stage output SROUTn to the first gate line G1. When the shift clocks (CKV2, CKVB2) and start signal STV2 are input only to the second gate driver circuit 3, the n-th gate line Gn through the first gate line G1 of the pixel array 1 are sequentially scanned, so that an image is displayed. This image is an inverted image of the image obtained by scanning effected by the first gate driver circuit 2.

The idea according to the present embodiment is characterized by an image display device in which the first and second gate driver circuits 2 and 3 formed of a plurality of shift registers, both scanning in one direction different from each other are formed on the same substrate on which the pixel array 1 are provided. Since the shift registers may be arranged in any configuration, the phase of shift clocks (single-phase, three-phase, or the like) is irrelevant to the invention. In the present embodiment, two-phase clocks are employed for ease of description, similarly to the aforementioned JP2004-246358.

As already described, the first and second gate driver circuit 2 and 3 are configured such that, when input control signals are at the voltage level of VSS, the shift registers do not operate to cause buffer amplifiers included in their output stages to have high impedance.

The control signal switching circuit 8 is a switching circuit capable of connecting a plurality of control signals necessary for the gate driver circuits output in response to the scan direction switching signal DIR, to one of the first and second gate driver circuits 2 and 3, and fixing the other one of the first and second gate driver circuits 2 and 3 at the fixed voltage VSS. In the example shown in FIG. 3, when the scan direction switching signal DIR is in the L level, the control signals are input to the first gate driver circuit 2 and the fixed voltage VSS is input to the second gate driver circuit 3, which results in a normal image display. On the contrary, when the scan direction switching signal DIR is in the H level, the fixed voltage VSS is input to the first gate driver circuit 2 and the control signals are input to the second gate driver circuit 3, which results in an inverted image display.

The control signal switching circuit 8 shown in FIG. 4 carries out the same operation.

### Effects of the Present Embodiment

The image display device is capable of switching the scanning direction as well as preventing a positive bias or a negative bias from being dc applied to gate electrodes of a-Si TFTs constituting the first and second gate driver circuits 2 and 3, which ensures a high degree of reliability.

Further, the gate driver circuits, arranged on the one side of the substrate, are respectively reduced in circuit area with no need to provide switching circuits shown in FIG. 17 for implementing the scan direction switching function and circuits compensating for the shift in threshold voltage (Vth) of TFT devices of such switching circuits. It is therefore possible to arrange a display area at the center of the outline of display panel. Furthermore, a narrow frame is achieved, provided that the display area is arranged at the center of the outline of display panel, and assuming that the left and right frames have the same size.

### Second Preferred Embodiment

The present embodiment features adding a power supply switching circuit to the image display device described in the first preferred embodiment. The power supply switching circuit switches a supply voltage of a power supply for the first and second gate driver circuits in response to an external signal so as to be applied to one of the first and second gate driver circuits controlled to be in the operating state. The power supply switching circuit fixes all or part of power terminals of the other gate driver circuit controlled not to operate, at the fixed voltage VSS such as GND of gate driver circuits in response to the external signal. Hereinafter, the present embodiment will be described with reference to the accompanied drawings.

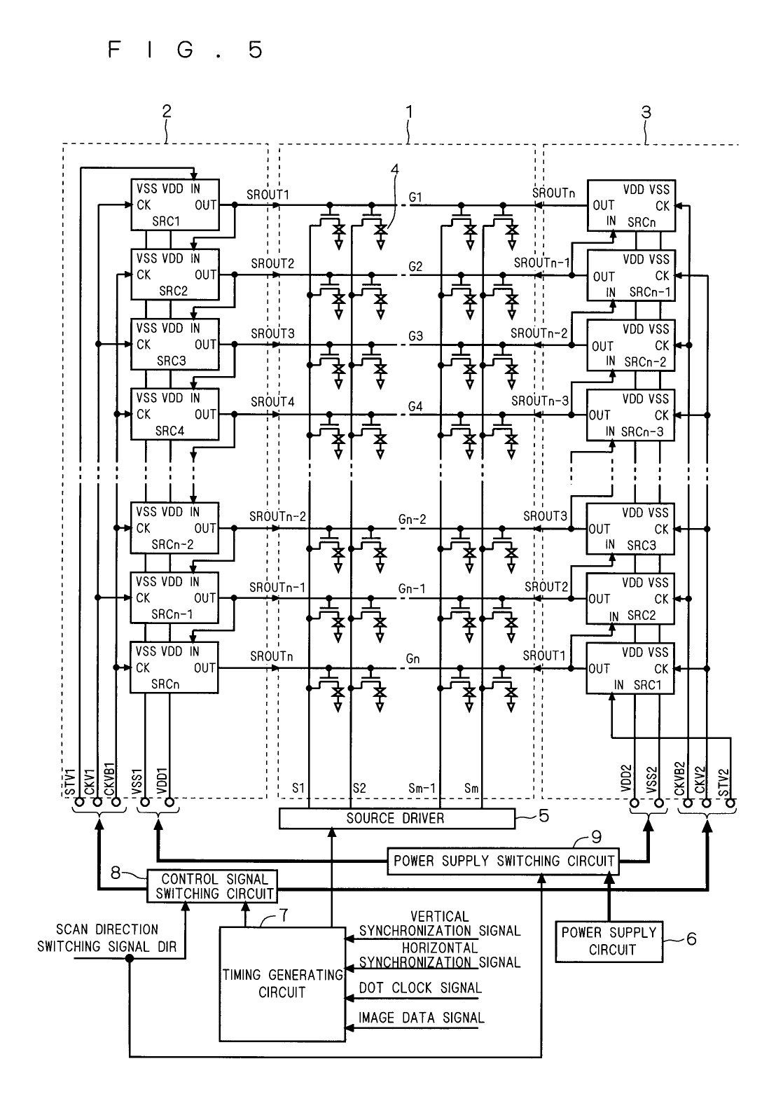

FIG. 5 is a block diagram showing an exemplary configuration of a liquid crystal display device according to the present embodiment, which differs from the device shown in FIG. 1 by an additionally provided power supply switching circuit 9, as already described.

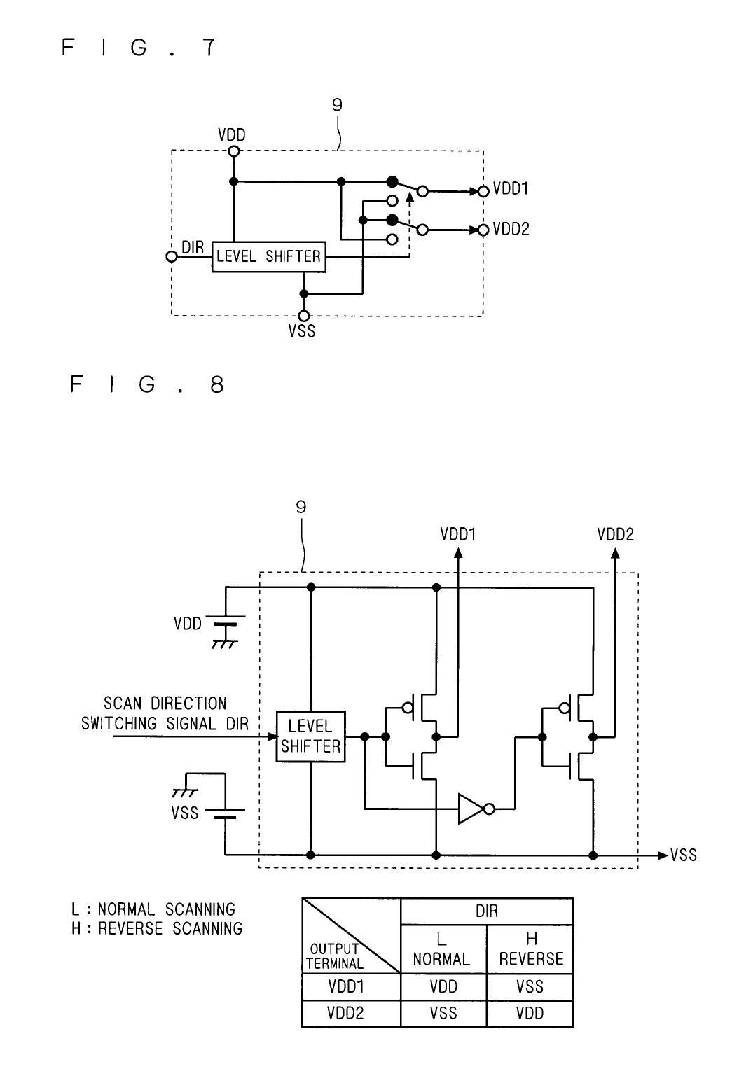

FIG. 7 is a circuit diagram showing an internal configuration of the power supply switching circuit 9, and the switch shown in FIG. 7 has a similar configuration as the circuit 11 shown in FIG. 4.

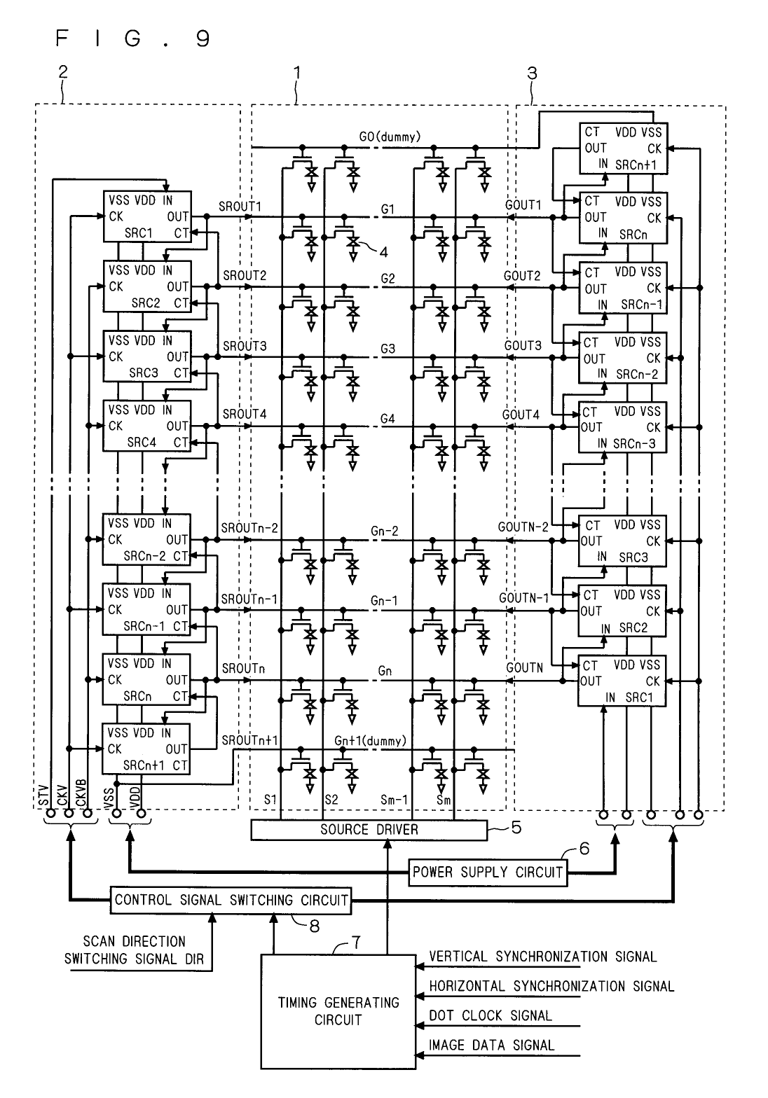

FIG. 8 is a circuit diagram showing another example of internal configuration of the power supply switching circuit 9, which differs from the circuit 11 shown in FIG. 4 by the transistor configuration of a switch for outputting power.

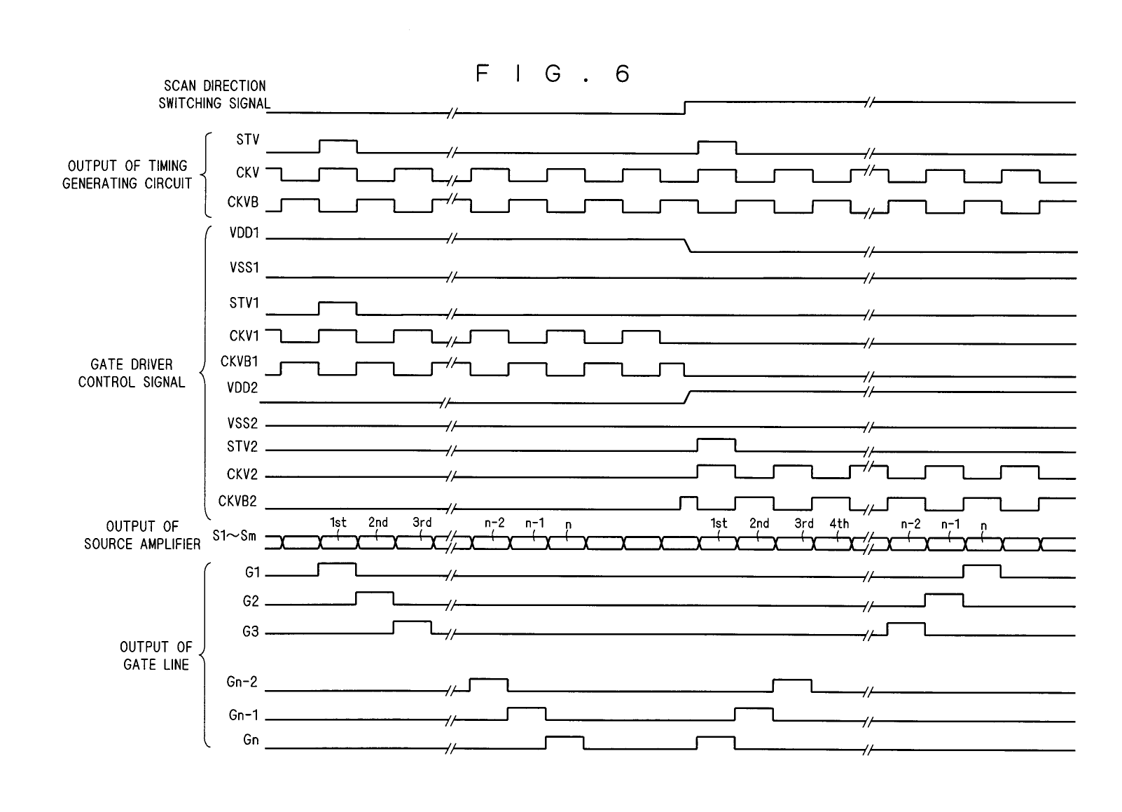

FIG. 6 is a timing chart showing the operation of the device shown in FIG. 5, which differs from that of FIG. 2 in that a positive power terminal VDD1 of the first gate driver circuit 2 and a positive power terminal VDD2 of the second gate driver circuit 3 each select one of the high voltage VDD and low voltage VSS in synchronization with the scan direction switching signal (external signal) DIR.

In the first preferred embodiment, control signals for the other gate driver circuit that is not used in line sequential scanning of the pixel array 1 are fixed at VSS, so that the other gate driver circuit is controlled to be in the non-operating state. In the present embodiment, control signals for the other gate driver circuit that is not used in line sequential scanning of the pixel array 1 and voltage applied to the positive power terminal are fixed at VSS, so that the other gate driver circuit is controlled to be in the non-operating state with more reliability.

### Effects of the Present Embodiment

In addition to the effects exerted by the first preferred embodiment, the present embodiment achieves effects of improving the circuit stability of the other gate driver circuit that is not used in line sequential scanning by fixing all potentials in the other gate driver circuit that is not used at the low potential VSS, to thereby prevent leakage in the circuit due to potential difference, and further, reducing power consumption.

### Third Preferred Embodiment

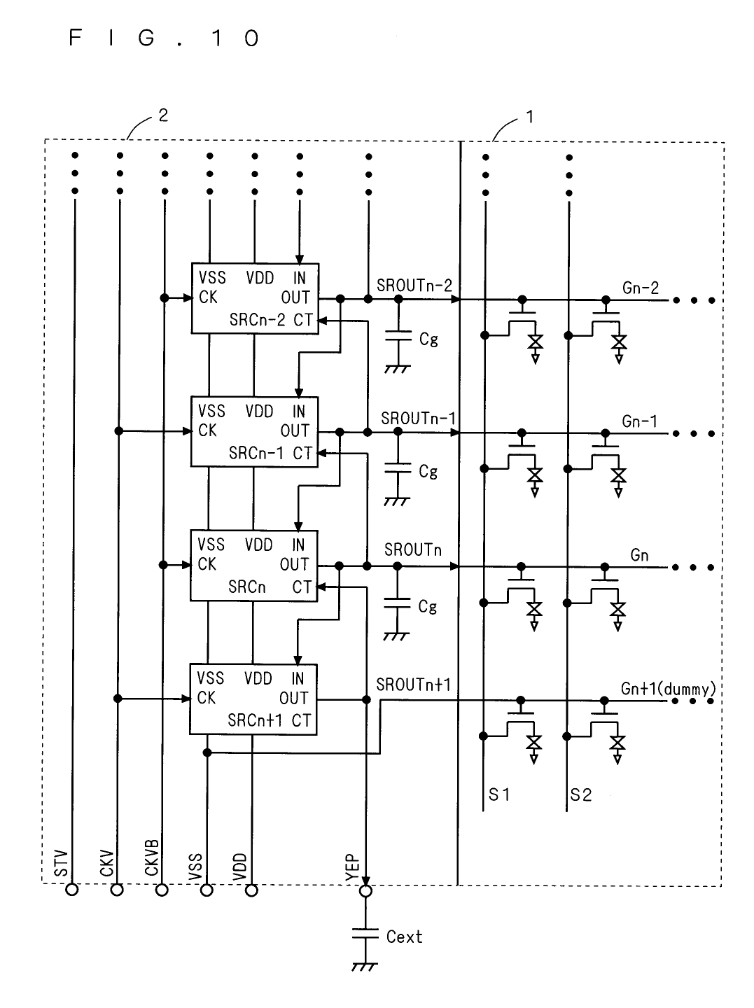

FIG. 9 is a circuit diagram showing a configuration of an image display device according to the present embodiment. The device shown in FIG. 9 is characterized in that shift registers in the image display device shown in FIG. 1 described in the first preferred embodiment are replaced with the shift registers shown in FIG. 2 of the aforementioned JP2004-246358.

Accordingly, in the device shown in FIG. 9, the first and second gate driver circuits 2 and 3 each include shift registers of (n+1) stages (one stage added) in order to reset the gate output of the shift register SRCn of the last stage. More specifically, in each of the first and second gate driver circuits 2 and 3, the output terminal OUT of the (n+1)th stage shift register SRCn+1 is connected only to the reset terminal CT of the shift register SRCn of the last stage. Further, in the device shown in FIG. 9, two dummy gate lines G0 and Gn+1 are provided in the pixel array 1, and are both routed to be fixed at VSS so as not to be subjected to line sequential scanning.

The operation and effects achieved by the present embodiment are similar to those described in the first preferred embodiment.

It should be noted that the power supply switching circuit 9 (FIG. 5) described in the second preferred embodiment may be applied to the present embodiment (FIG. 9).

### Fourth Preferred Embodiment

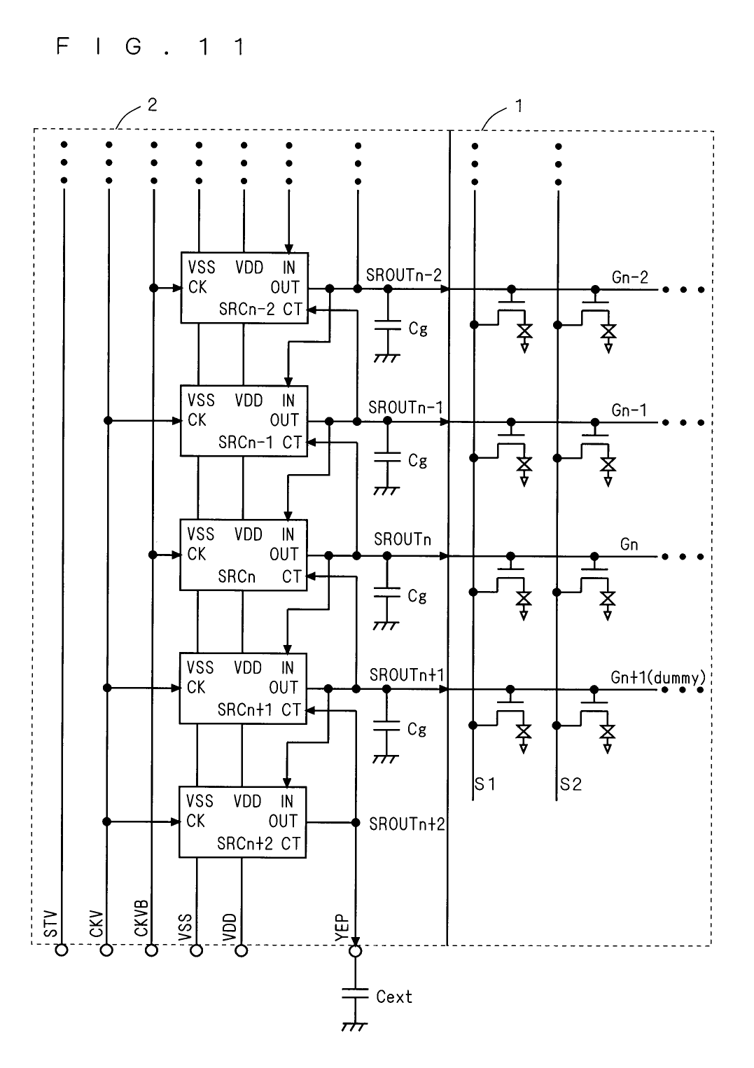

FIG. 10 is an enlarged circuit diagram showing the latter half of the shift registers shown in FIG. 9, in connection with the third preferred embodiment. The method of extracting an end pulse output to the outside is illustrated.

As shown in FIG. 10, the output terminal OUT of the (n+1)th stage shift register SRCn+1 is connected to the reset terminal CT of the n-th stage shift register SRCn and also to a terminal YEP for extraction to the outside of the substrate. That is, in the example shown in FIG. 10, a reset signal corresponding to the output signal from the shift register SRCn+1 subsequent to the last stage shift register SRCn is used as an end pulse output signal for the monitor of the present image display device.

It should be noted that the above-described configuration of the shift registers and the extraction terminal YEP shown in FIG. 10 may be provided similarly for the second gate driver circuit 3.

With the circuit configuration shown in FIG. 10, failure/no-failure test of shift registers is carried out by detecting the end pulse output for the monitor, which achieves effective check of the shift registers before the panel mounting step in the manufacturing process.

In the case of extracting the end pulse output to the outside, the waveform of the end pulse output is different from that of other gate line outputs since the parasitic capacitance of the end pulse output line is different from that of gate lines. When the parasitic capacitance of the end pulse output line is greater than that of gate lines, the end pulse output has a waveform rounded more than those of the gate lines. Using such rounded waveform as the reset signal for the n-th stage shift register SRCn as shown in the configuration of FIG. 10, the waveform for driving the gate line Gn of the last stage differs from those of other gate lines. The reset signal for each shift register exerts influence upon falling of the waveform for driving a corresponding gate line. Therefore, in this case, gate turn-off is delayed only for the gate line Gn of the last stage, which in turn causes reduced operating margin of the gate driver circuits.

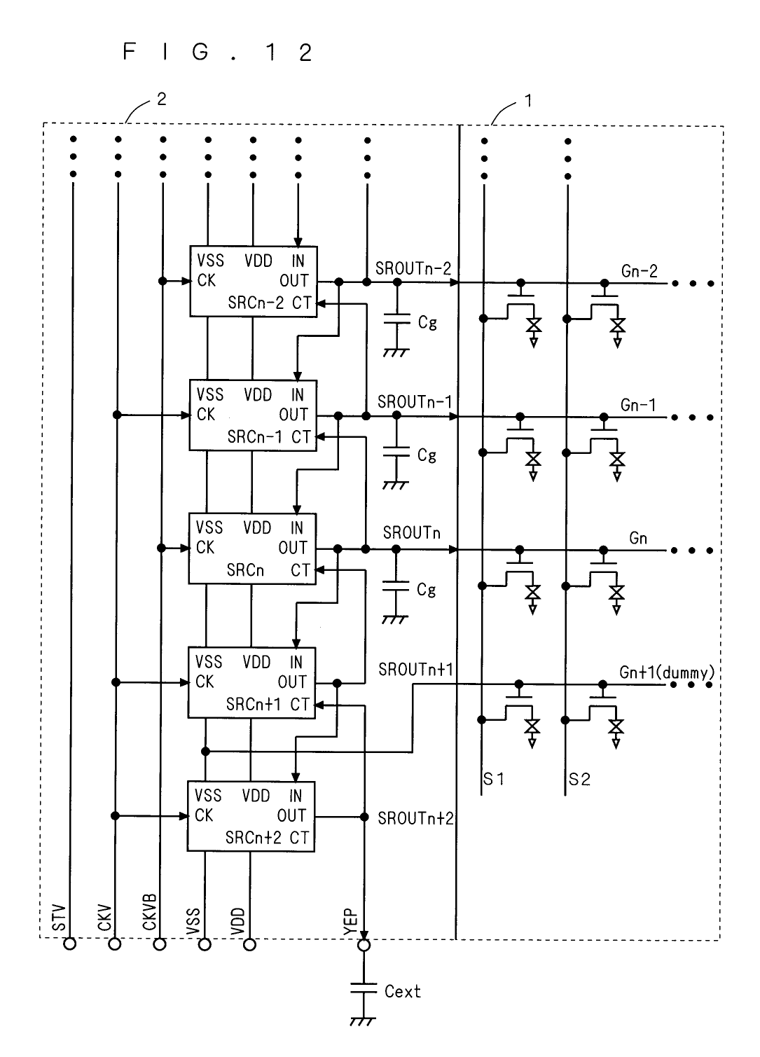

To solve such problem, the circuit configuration shown in FIG. 11 is presented. In an image display device shown in FIG. 11, a shift register SRCn+2 of the (n+2)th stage is added to the shift registers of the first gate driver circuit 2 shown in FIG. 10, so that the reset signal for the n-th stage shift register SRCn and end pulse output signal for the monitor are separated. More specifically, the output signal OUT from the (n+2)th stage shift register SRCn+2 is applied to the extraction terminal YEP as an end pulse output signal by routing the end pulse output line, and is also applied to the (n+1)th stage shift register SRCn+1 for driving the dummy gate line Gn+1, as a reset signal. Herein, the output of the (n+1)th stage shift register SRCn+1 is connected to the dummy gate line Gn+1 so as to provide the same load as the other stages. Therefore, the reset signal output from the (n+1)th stage shift register SRCn+1 is not connected to the end pulse output line, and thus its waveform is not rounded, so that gate turn-off of the gate line Gn of the last stage is not delayed as compared to the other gate lines.

As described, the circuit configuration shown in FIG. 11 improves the operating margin of the gate driver circuit 2 (3) by separating the reset signal for the n-th stage shift register SRCn and end pulse output signal for the monitor.

The circuit configuration shown in FIG. 11 may also be applied to the second gate driver circuit 3.

### Effects of the Present Embodiment

The circuit configuration shown in FIG. 11 achieves (1) improved operating margin of the gate driver circuits, and (2) almost the same waveform of all the gate lines G1 to Gn.

### Fifth Preferred Embodiment

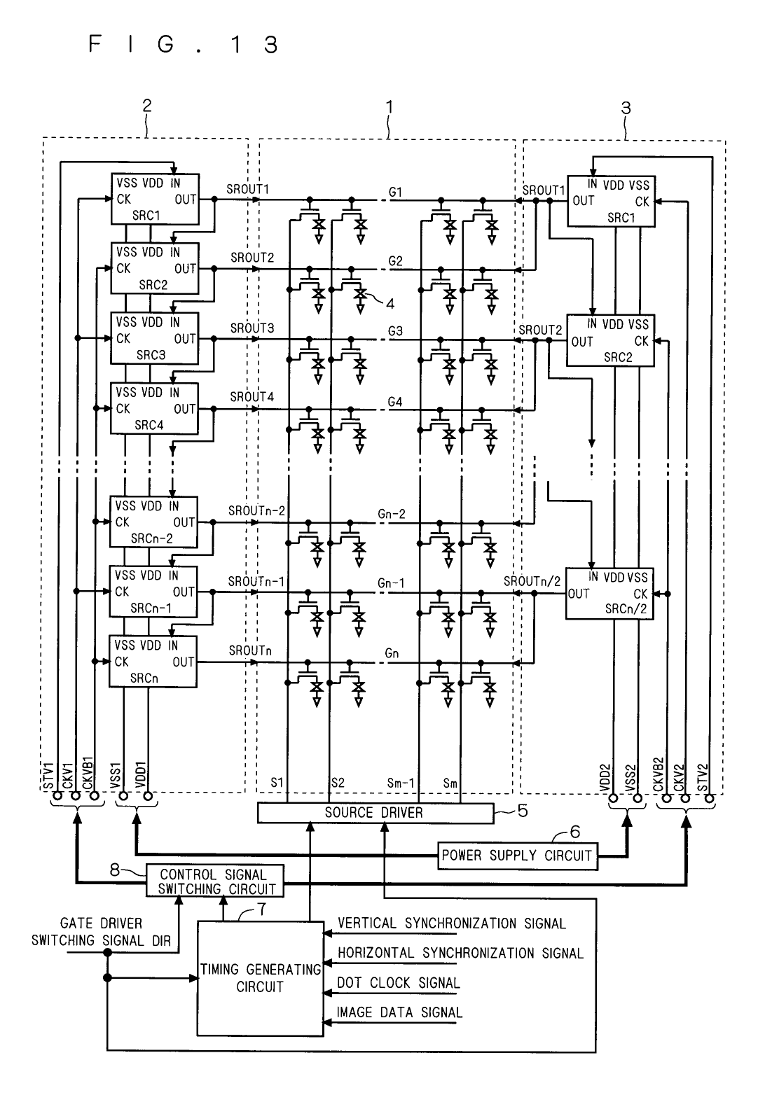

The present embodiment features changing the circuit shown in FIG. 11 according to the fourth preferred embodiment to the circuit shown in FIG. 12. More specifically, the circuit shown in FIG. 12 differs from that of FIG. 11 in that the output terminal OUT of the (n+1)th stage shift register SRCn+1 is separated from the dummy gate line Gn+1 (Dummy), and the dummy gate line Gn+1 is routed to VSS (threshold voltage of a-Si TFTs to potential at the ground level or below).

Accordingly, the circuit shown in FIG. 12 operates in the same manner as in the fourth preferred embodiment. Particularly, the load on the output of the (n+1)th stage shift register SRCn+1 is lighter than in the fourth preferred embodiment, so that gate turn-off of the gate line Gn of the last stage is faster than the other gate lines.

The circuit configuration shown in FIG. 11 may also be applied to the second gate driver circuit 3.

### Effects of the Present Embodiment

The circuit configuration shown in FIG. 12 achieves improved operating margin of the gate driver circuits.

### Sixth Preferred Embodiment

The present embodiment features implementing a resolution switching function in a panel including a-Si gate driver circuits. For this purpose, in the image display device according to the present embodiment, the first and second gate driver circuits are different in the number of stages of shift registers. This feature will be described below with reference to the drawings.

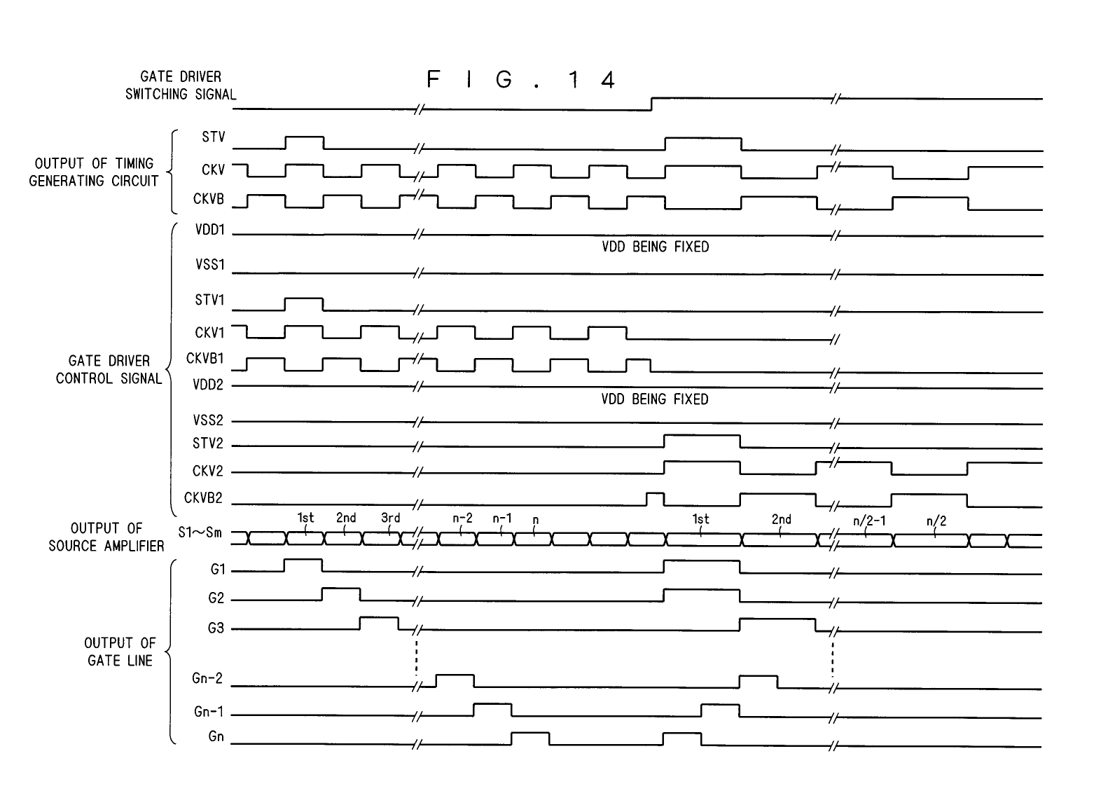

FIG. 13 is a block diagram showing a configuration of the image display device according to the present embodiment.

The device shown in FIG. 13 differs from that of FIG. 11 by: (1) the number of stages of shift registers of the second gate driver circuit 3 (n/2: half that of the first gate driver circuit 2); and (2) the method of routing of the second gate driver circuit 3 to the gate lines. The shift registers of the second gate driver circuit 3 are connected to the gate lines such that SROUT1 is connected to the gate lines G1 and G2, SROUT2 to G3 and G4, . . . , SROUTn/2 to Gn−1 and Gn.

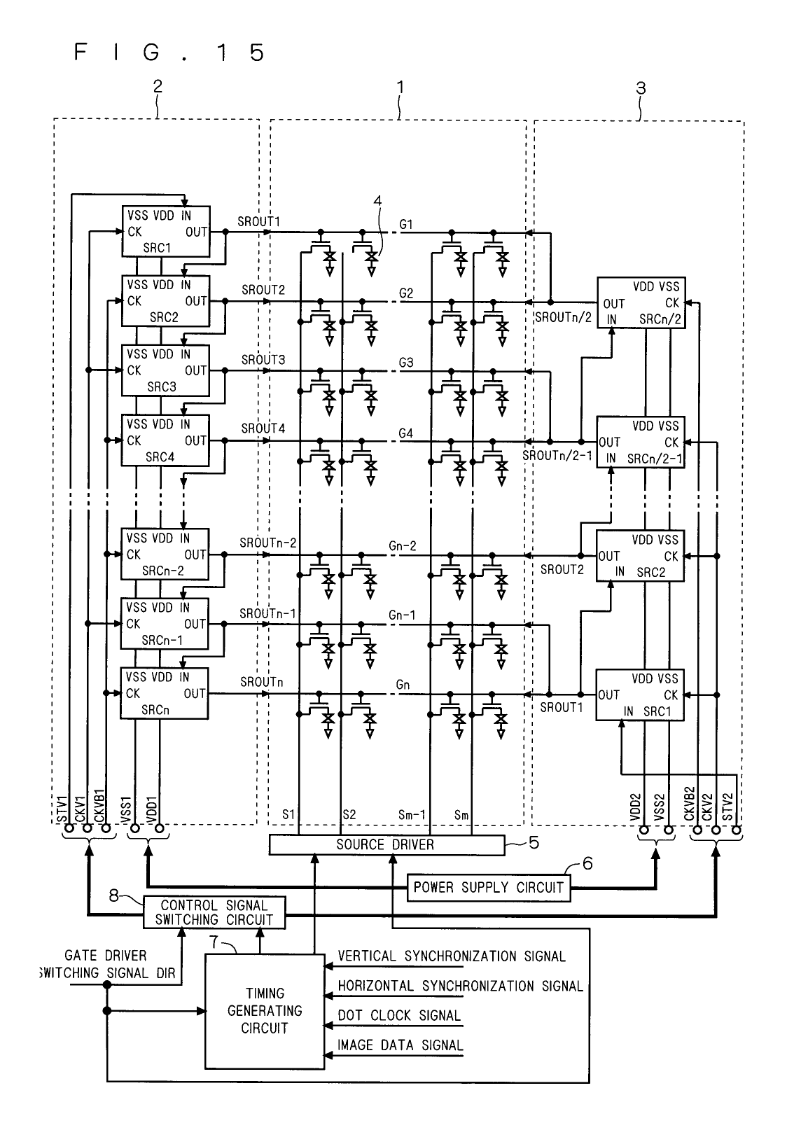

In connection with the operation of the device, FIG. 14 shows a timing chart of the device shown in FIG. 13. The device shown in FIG. 14 differs in operation from the device shown in FIG. 2 in that: the driving frequency of the second gate driver circuit 3 is half that of the first gate driver circuit 2 in synchronization with a gate driver switching signal DIR; and that the operating frequency of the output from the source driver is half and image data is half as compared with the period in which the first gate driver circuit 2 is driven.

The timing generating circuit 7 and source driver 5 generate image data in synchronization with the gate driver switching signal DIR as shown in the timing chart of FIG. 14 (explanation of which is omitted).

The idea of the power supply switching circuit already described in the second preferred embodiment may be added to the circuit according to the present embodiment (explanation of which is omitted).

In the present embodiment, the resolution is switched such that the resolution in the direction which the gate lines extend is reduced to half, however, the ratio of switching the resolution may be varied by changing the routing of the outputs from the respective shift registers of the second gate driver circuit 3 and gate lines.

### Effects of the Present Embodiment

The present embodiment allows images with different resolutions (e.g., VGA (640×480) and QVGA (320×240) to be displayed in the same display area on the same panel.

### Seventh Preferred Embodiment

The present embodiment features implementing the resolution switching function described in the sixth preferred embodiment in a panel including a-Si gate driver circuits in addition to the scan direction switching function.

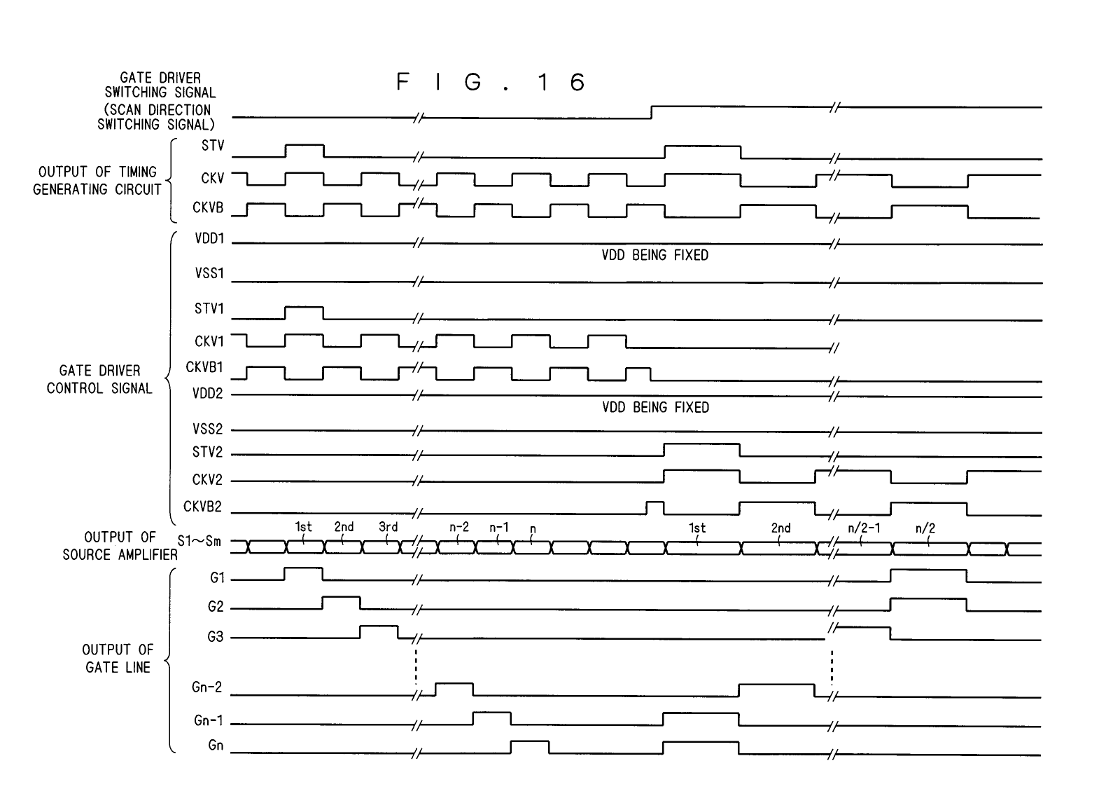

FIG. 15 is a block diagram showing a configuration of an image display device according to the present embodiment. The circuit configuration shown in FIG. 15 corresponds to a combination of the circuit (FIG. 1) according to the first preferred embodiment and the circuit (FIG. 13) according to the sixth preferred embodiment. It is needless to say that the technical idea described in the second preferred embodiment may be additionally applied to the circuit shown in FIG. 15.

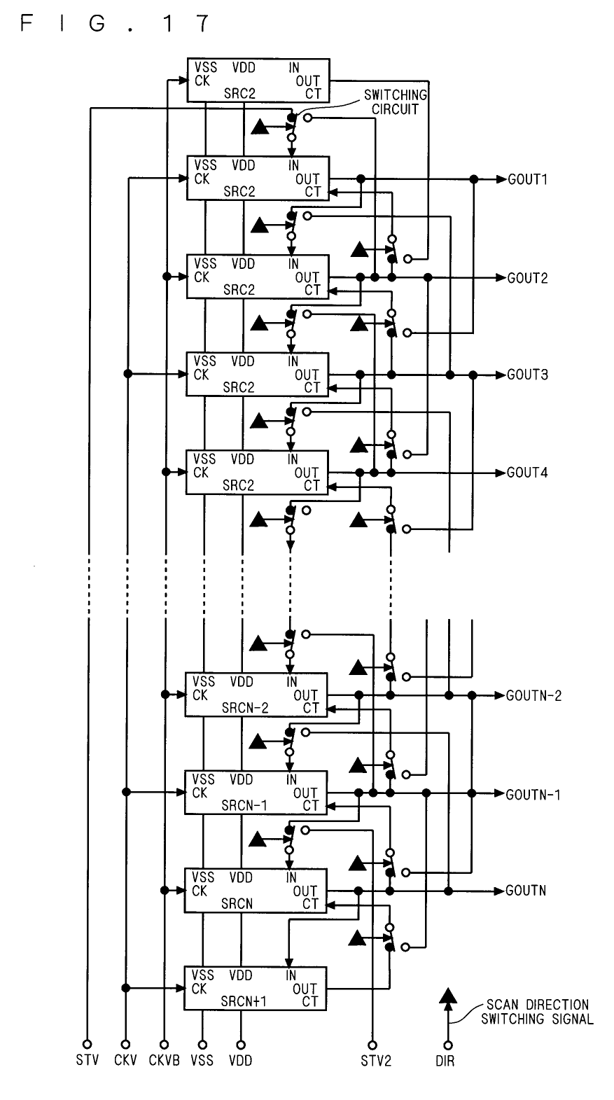

FIG. 16 is a timing chart showing the operation of the circuit shown in FIG. 15, which is the same in driving timing as that of FIG. 14, but differs in that, when the second gate driver circuit 3 is selected, a display image becomes an inverted image by reverse scanning, and the display resolution is switched to be reduced to half as compared to the period in which the first gate driver circuit 2 is selected.

It should be noted that, according to the present embodiment, the ratio of switching the resolution may also be varied by changing the routing of the outputs from the respective shift registers of the second gate driver circuit 3 and gate lines.

### Effects of the Present Embodiment

The present embodiment achieves reverse scanning and at the same time allows images with different resolutions (e.g., VGA (640×480) and QVGA (320×240) to be displayed in the same display area on the same panel, to thereby display image data as an inverted image.

While the invention has been shown and described in detail, the foregoing description is in all aspects illustrative and not restrictive. It is therefore understood that numerous modifications and variations can be devised without departing from the scope of the invention.

The present invention is suitably applied to an image display device having a panel including a-Si gate driver circuits.

What is claimed is:

1. An image display device comprising, on a single substrate:
a plurality of pixels arrayed in a matrix;
a plurality of gate lines and a plurality of source lines defining said matrix;
a first gate driver circuit scanning said plurality of gate lines in a first direction, including gate pulse output stages each being capable of having high impedance in response to an external signal; and
a second gate driver circuit scanning said plurality of gate lines in a second direction, including gate pulse output stages each being capable of having high impedance in response to said external signal, wherein
each of the gate pulse output stages of said first gate driver circuit and each of the gate pulse output stages of said second gate driver circuit are connected to each other through a corresponding gate line, and
when one of said first and second gate driver circuits is operating under the control of said external signal, the gate pulse output stages of the other one of said first and second gate driver circuits have high impedance, so that the other one of said first and second gate driver circuits exerts no influence upon scanning effected by the operating one of said first and second gate driver circuits.

2. The image display device according to claim 1, wherein
said first and second gate driver circuits are both composed of amorphous silicon TFTs.

3. The image display device according to claim 1, wherein
said one of said first and second gate driver circuits is brought into an operating state by application of a voltage-unfixed control signal,
said image display device further comprising a control signal switching circuit configured to switch application of said voltage-unfixed control signal to said first and second gate driver circuits in response to said external signal.

4. The image display device according to claim 1, further comprising a power supply switching circuit configured to switch application of a supply voltage of a power supply circuit for said first and second gate driver circuits in response to said external signal such that said supply voltage is applied to said one of said first and second gate driver circuits.

5. The image display device according to claim 1, wherein
one of said first and second gate driver circuits comprises an immediately subsequent stage shift register outputting a reset signal for a last shift register including a gate pulse output stage connected to a gate line to be scanned at last among said plurality of gate lines, from an output terminal thereof, said immediately subsequent stage shift register immediately subsequent to said last shift register, the immediately subsequent stage shift register receiving, as an input signal thereof, an output signal from said last shift register and,
said reset signal corresponding to an output signal from said output terminal of the immediately subsequent stage shift register is an end pulse output for a monitor of said image display device.

6. The image display device according to claim 1, wherein
one of said first and second gate driver circuits comprises:
an immediately subsequent stage shift register immediately subsequent to a shift register including a gate pulse output stage connected to a gate line to be scanned at last among said plurality of gate lines, the immediately subsequent shift register outputting, from an output terminal, a reset signal for its immediately preceding shift register, and receiving, as an input signal, an output from the immediately preceding shift register; and
a second subsequent stage shift register subsequent to said immediately subsequent shift register receiving, as an input signal, an output signal from said immediately subsequent stage shift register, and outputting an output signal as a reset signal for said immediately subsequent stage shift register, wherein
said output signal from said second subsequent stage shift register is used as an end pulse output for a monitor of said image display device, and
the output terminal of said immediately subsequent stage shift register is connected also to a dummy gate line provided outside said gate line to be scanned at last, to thereby provide the same output load.

7. The image display device according to claim 1, wherein
one of said first and second gate driver circuits comprises:
an immediately subsequent stage shift register immediately subsequent to a shift register including a gate pulse output stage connected to a gate line to be scanned at last among said plurality of gate lines, the immediately subsequent shift register outputting, from an output terminal, a reset signal for its immediately preceding shift register, and receiving, as an input signal, an output from the immediately preceding shift register; and
a second subsequent stage shift register subsequent to said immediately subsequent shift register receiving, as an input signal, an output signal from said immediately subsequent stage shift register, and outputting an output signal as a reset signal for said immediately subsequent stage shift register, wherein
said output signal from said second subsequent stage shift register is an end pulse output for a monitor of said image display device, and
a dummy gate line provided outside said gate line to be scanned at last is fixed at a potential at a ground level or below.

8. The image display device according to claim 1, wherein
said first and second gate driver circuits are different in the number of stages of shift registers connected through said plurality of gate lines.

9. An image display device comprising, on a single substrate:
a plurality of pixels arrayed in a matrix;
a plurality of gate lines and a plurality of source lines defining said matrix;
a first gate driver circuit scanning said plurality of gate lines in a first direction, including gate pulse output stages each being capable of having high impedance in response to an external signal; and
a second gate driver circuit scanning said plurality of gate lines in said first direction, including gate pulse output stages each being capable of having high impedance in response to said external signal, wherein
said first and second gate driver circuits are different in the number of stages of shift registers connected through said plurality of gate lines.
